(19) United States
(12) Patent Application Publication
(10) Pub. No.: US 2009/0295268 A1
(43) Pub. Date: Dec. 3, 2009

(54) LAMP ASSEMBLY

(75) Inventor: CHANG-HUNG PENG, Taipei Hsien (TW)

Correspondence Address: WPAT, PC;INTELLECTUAL PROPERTY ATTORNEYS, 7225 BEVERLY ST., ANNANDALE, VA, 22003, US

(73) Assignee: COOLER MASTER CO., LTD., Taipei Hsien (TW)

(21) Appl. No.: 12/472,190

(22) Filed: May 26, 2009

(30) Foreign Application Priority Data
May 28, 2008 (TW) 097209350

(51) Int. Cl. H01J 5/50

(52) U.S. Cl. 313/318.04; 313/318.01

(57) ABSTRACT

A lamp assembly includes a lamp body, a light emitting module and a joint. The lamp body has a housing which has a supporting portion formed on one end thereof, and the supporting portion has a hatch defined therein. The light emitting module includes a circuit board disposed in the supporting portion and electrically connected with a first electrode and a second electrode, wherein the first electrode passes through the hatch and is located on an outer surface of the supporting portion. The joint includes a metal shell, an insulator formed over the metal shell and a conducting plane disposed over the insulator. The metal shell and the supporting portion are combined with each other so that the metal shell is electrically connected with the first electrode and the second electrode is electrically connected with the conducting plane.

### BACKGROUND OF THE INVENTION

1. Field of the Invention

The present invention relates to a lamp assembly, and more particularly to a bulb-typed lamp assembly.

2. Description of Related Art

Conventional bulbs generally include incandescent bulbs, energy-saving bulbs, and LED bulbs and so on. Each of the bulbs may have an Edison joint disposed on the end of the bulb body or the bulb cover thereof. Once the joints are screwed onto bulb holders for power sources, the bulbs are turned on.

A conventional bulb, as shown in FIG. 1, which is disclosed in Taiwan Patent Certificate No. M305303, entitled “DAYLIGHT LAMP ASSEMBLY”, has a circuit board 20a disposed in a bulb body 10a of the bulb. The circuit board 20a has a first conducting wire 30a and a second conducting wire 40a disposed thereon, wherein the first conducting wire 30a is welded on a threaded wall 501a of a joint 50a of the bulb and the second conducting wire 40a is welded on a conducting plane 70a of a surface of an insulator 60a of the joint 50a. When the joint 50a is screwed on the bulb holders for power sources, the threaded wall 501a and the conducting plane 70a of the joint 50a are electrified and then transmit electric energy into the circuit board 20a via the first conducting wire 30a and the second conducting wire 40a, so that the circuit board 20a drives a light emitting element 80a to emit light.

The first conducting wire 30a and the second conducting wire 40a of the bulb described above are connected with the joint 50a and the conducting plane 70a by welding. However, the welding manufacture is time and labor consuming, so the manufacturing cost is high.

### SUMMARY OF THE INVENTION

A main object of the present invention is to provide a lamp assembly which electrically connects two electrodes on a circuit board and a joint via screwing so that bulb manufacture is much easier and manufacture cost is reduced.

To achieve the above-mentioned object, a lamp assembly in accordance with the present invention is provided. The lamp assembly includes a lamp body, a light emitting module and a joint. The lamp body has a housing which has a supporting portion formed on one end thereof, and the supporting portion has a hatch defined therein. The light emitting module includes a circuit board disposed in the supporting portion and electrically connected with a first electrode and a second electrode, the first electrode passing through the hatch and located on an outer surface of the supporting portion. The joint includes a metal shell, an insulator formed over the metal shell and a conducting plane disposed over the insulator. The metal shell and the supporting portion are combined with each other so that the metal shell is electrically connected with the first electrode and the second electrode is electrically connected with the conducting plane.

### BRIEF DESCRIPTION OF THE DRAWINGS

FIG. 1 is an exploded view of a conventional lamp assembly;

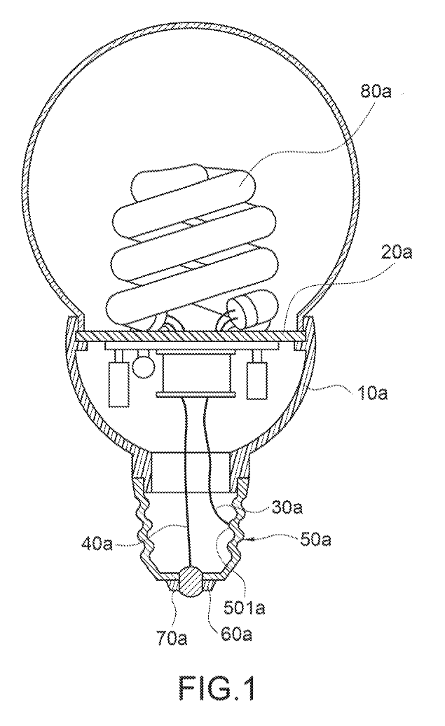

FIG. 2 is a partially perspective view of a lamp assembly of the present invention;

FIG. 3 is a partially exploded perspective view of the lamp assembly of the present invention;

FIG. 4a is a partially cross-sectional view of the lamp assembly of the present invention;

FIG. 4b is a partially enlarged view of FIG. 4a; and

FIG. 5 is a partially exploded perspective view of another embodiment of the lamp assembly of the present invention.

### DETAILED DESCRIPTION OF THE PREFERRED EMBODIMENTS

To further understand technical contents and detailed description of the present invention, please refer to the following description in combination with the accompanying drawings.

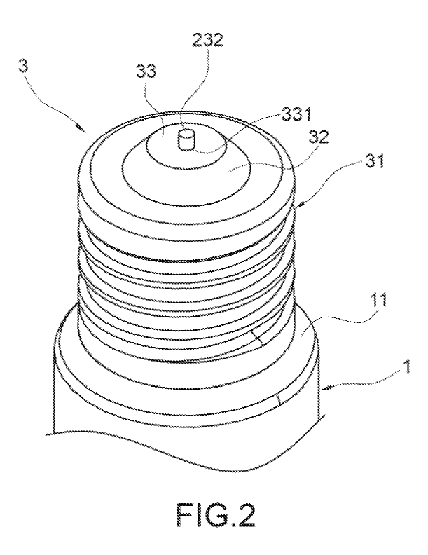

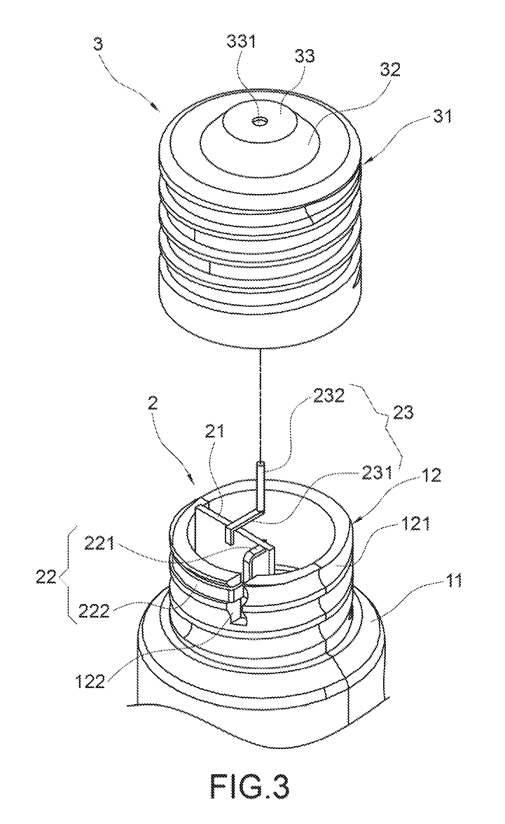

Please refer to FIG. 2 and FIG. 3 which are respectively a partially perspective view and a partially exploded perspective view of a lamp assembly in accordance with the present invention. As shown in FIG. 2 and FIG. 3, the lamp assembly of the present invention includes a lamp body 1, a light emitting module 2 and a joint 3.

The lamp body 1 includes a housing 11 with a supporting portion 12 formed on one end of the housing 11. In the embodiment, the supporting portion 12 is a cylindrical body which has an outer screw thread 121 formed on the periphery thereof and a hatch 122 defined in one side thereof.

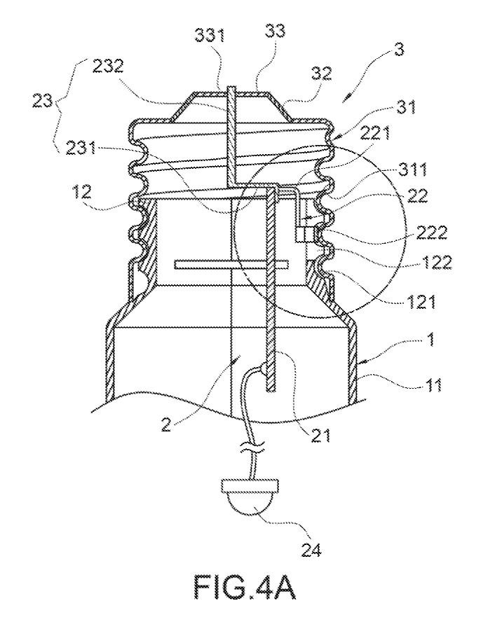

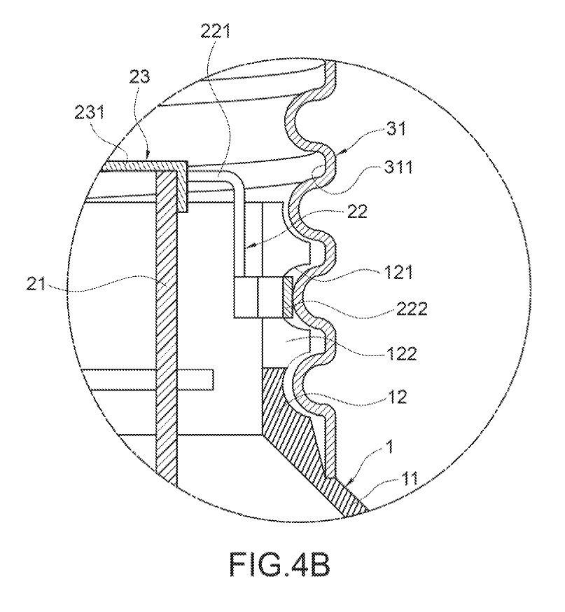

The light emitting module 2 includes a circuit board 21 and a light emitting element 24 electrically connected with the circuit board 21 (as shown in FIG. 4a), such as an energy-saving bulb or LED. The circuit board 21 is disposed in the cavity of the supporting portion 12 of the lamp body 1. Furthermore, a first electrode 22 and a second electrode 23 are electrically connected with the circuit board 21. In the embodiment, the first electrode 22 includes a sheet-like conducting terminal 221 having the shape of an inverted L and an arc-shaped conducting strip 222 extending from the conducting terminal 221, wherein the conducting terminal 221 is connected with the circuit board 21, and the inner side surface of the arc-shaped conducting strip 222 is attached to the walls of the hatch 122 and the outer screw thread 121 and formed on the surface of the screw thread 121 (as shown in FIG. 3). The second electrode 23 of the embodiment includes a sheet-like conducting terminal 231 having an L-shape and a cylindrical connecting pole 232 extending vertically from the conducting terminal 231, and the conducting terminal 231is connected with the circuit board 21.

The joint 3 includes a hollow metal shell 31, an insulator 32 formed over the metal shell 31 and a conducting plane 33 disposed over the insulator 32. The metal shell 31 has an inner screw thread 311 formed therein, which engages with the outer screw thread 121 of the lamp body 1 via threaded connection. The insulator 32 is conical in shape. The conducting plane 33 has a through-hole 331 formed therein, thereby the conducting pole 232 of the second electrode 23 may pass through the through-hole 331 and be electrically connected with the conducting plane 33.

Please refer to FIG. 4a and FIG. 4b which are respectively a cross-sectional view and a partially enlarged view of the lamp assembly of the present invention. In assembly, firstly, the circuit board 21 is clamped and positioned in the housing 11; then, the inner screw thread 311 of the metal shell 31 is engaged with the outer screw thread 121 of the lamp body 1 and the conducting strip 222 is clamped between the metal shell 31 and the supporting portion 12; and further, the conducting pole 232 passes through and contacts with the through-hole 331 of the conducting plane 33. Accordingly, the assembly of the lamp assembly is completed.

Because the joint 3 and the first electrode 22 and the second electrode 23 of the circuit board 21 are electrically connected via screwing, so the bulb manufacture is much easier, the manufacturing time is shortened and the working procedure is reduced, thereby reducing the manufacturing costs and electrical failure.

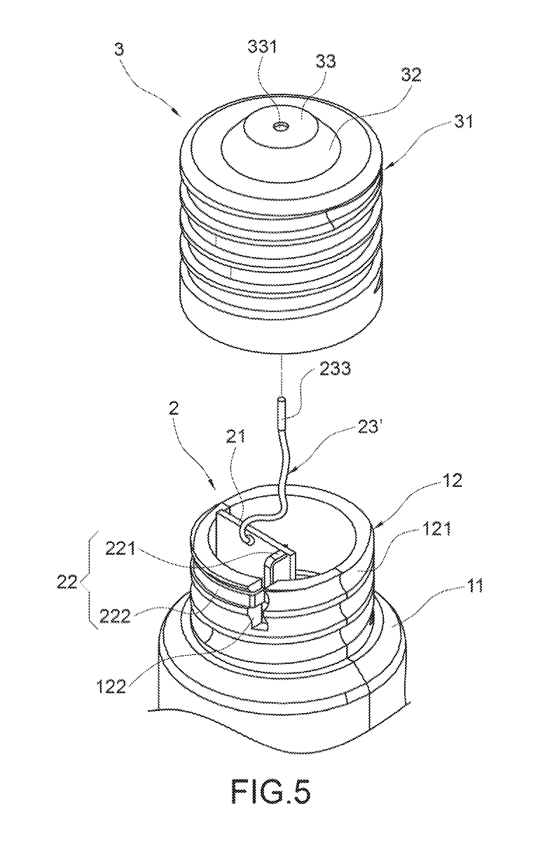

Additionally, another preferred embodiment of the present invention is shown in FIG. 5. The difference between the embodiment in FIG. 5 and the embodiment in FIG. 3 is that the embodiment in FIG. 5 uses a metal conducting wire 23′ with a metal joint 233 shown in FIG. 5 to replace the second electrode 23 shown in FIG. 3.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A lamp assembly, comprising:
a lamp body, having a housing which has a supporting portion formed on one end thereof, the supporting portion having a hatch defined therein;
a light emitting module, including a circuit board disposed in the supporting portion and electrically connected with a first electrode and a second electrode, the first electrode passing through the hatch and located on an outer surface of the supporting portion; and
a joint, including a metal shell, an insulator formed over the metal shell and a conducting plane disposed over the insulator;
wherein the metal shell and the supporting portion are combined with each other so that the metal shell is electrically connected with the first electrode and the second electrode is electrically connected with the conducting plane.

2. The lamp assembly as claimed in claim 1, wherein the housing is made of a plastic material.

3. The lamp assembly as claimed in claim 1, wherein the supporting portion is a cylindrical body which has an outer screw thread formed on an outer surface thereof, the metal shell has an inner screw thread formed therein, and the supporting portion and the metal shell engage with each other via threaded connection.

4. The lamp assembly as claimed in claim 3, wherein the first electrode has a conducting strip clamped between the supporting portion and the metal shell.

5. The lamp assembly as claimed in claim 4, wherein the first electrode further includes a conducting terminal extending from the conducting strip, and the conducting terminal is connected with the circuit board.

6. The lamp assembly as claimed in claim 4, wherein the conducting strip is arc-shaped, and an inner side surface of the arc-shaped conducting strip is attached to walls of the hatch and the outer screw thread and formed on a surface of the outer screw thread.

7. The lamp assembly as claimed in claim 1, wherein the conducting plane has a through-hole and the second electrode has a conducting pole of which one end passes through and contacts with the through-hole.

8. The lamp assembly as claimed in claim 7, wherein the second electrode further includes a conducting terminal extending from the conducting pole, and the conducting terminal is connected with the circuit board.

9. The lamp assembly as claimed in claim 7, wherein the conducting pole has a vertically extending structure relationship with the conducting terminal.

10. The lamp assembly as claimed in claim 1, wherein the light emitting module further includes a light emitting element electrically connected with the circuit board, and the insulator is a conical insulator.

11. A lamp assembly, comprising:
a lamp body, having a housing which has a supporting portion formed on one end thereof, the supporting portion having a hatch defined therein;
a light emitting module, including a circuit board disposed in the supporting portion and electrically connected with an electrode, the electrode including a conducting strip and a conducting terminal, wherein the conducting strip passes through the hatch and is located on an outer surface of the supporting portion and the conducting terminal is connected with the circuit board; and
a joint, including a metal shell, an insulator formed over the metal shell and a conducting plane disposed over the insulator;
wherein the metal shell and the supporting portion are combined with each other so that the metal shell is electrically connected with the electrode and the conducting plane is electrically connected with the circuit board by an additional electrical connection means.

12. The lamp assembly as claimed in claim 11, wherein the supporting portion is a cylindrical body which has an outer screw thread formed on an outer surface thereof, the metal shell has an inner screw thread formed therein, and the outer screw thread and the inner screw thread engage with each other via threaded connection so that the conducting strip is clamped between the supporting portion and the metal shell.

13. The lamp assembly as claimed in claim 12, wherein the conducting strip is an arc-shaped conducting strip extending from the conducting terminal, and an inner side surface of the arc-shaped conducting strip is attached to walls of the hatch and the outer screw thread and formed on a surface of the outer screw thread.

14. The lamp assembly as claimed in claim 11, wherein the additional electrical connection means is an additional electrode which includes a conducting pole and an additional conducting terminal extending from the conducting pole.

15. The lamp assembly as claimed in claim 14, wherein the conducting plane has a through-hole and an end of the conducting pole passes through and contacts with the through-hole, and the additional conducting terminal is connected with the circuit board.

16. The lamp assembly as claimed in claim 14, wherein the conducting pole has a vertically extending structure relationship with the additional conducting terminal.

17. The lamp assembly as claimed in claim 11, wherein the light emitting module further includes a light emitting element electrically connected with the circuit board.

18. The lamp assembly as claimed in claim 11, wherein the insulator is a conical insulator.

19. The lamp assembly as claimed in claim 11, wherein the additional electrical connection means is a metal conducting wire with a metal joint.
